(19) United States
(12) Patent Application Publication
(10) Pub. No.: US 2017/0266801 A1
(43) Pub. Date: Sep. 21, 2017

(54) SINGLE-HANDED OPERABLE HAND TOOL WITH MEASURING DEVICE

(71) Applicant: Erik Slansky, Honolulu, HI (US)

(72) Inventor: Erik Slansky, Honolulu, HI (US)

(21) Appl. No.: 15/460,535

(22) Filed: Mar. 16, 2017

Related U.S. Application Data
(60) Provisional application No. 62/310,571, filed on Mar. 18, 2016.

(51) Int. Cl. B25D 1/04; B25G 1/00; G01B 3/00

(52) U.S. Cl. CPC B25D 1/04; G01B 3/004; B25G 1/00

(57) ABSTRACT

A hand tool is disclosed for driving nails, screws, and the like into a surface that improves the speed and accuracy with which it may be used by incorporating a measuring tool enabling the user to use the tool and measure distances with a single hand.

### CROSS-REFERENCE TO RELATED APPLICATIONS

The present application is related to and claims the benefit of U.S. Provisional Patent Application Ser. No. 62/310,571, titled “QUICK STICK” filed on Mar. 18, 2016, which is hereby incorporated by reference.

### BACKGROUND OF THE INVENTION

When working with a hammer, it may be necessary to take measurements. This is especially true for carpenters on the job. In order to take a measurement, the individual has to reach for their tape measure and put down their hammer. A traditional tape measure requires two hands for use, so it is not possible to continue to hold the hammer while measuring. Many times an individual does not want to waste the time locating the tape measure and will just estimate their work. A more convenient method is desired. A suitable solution is desired.

### BRIEF SUMMARY OF THE INVENTION

Many individuals use hand tools for various tasks. The present invention virtually eliminates the need for an individual to reach for their tape measure while working with a hand tool, such as a hammer. The device, as designed, provides users with both a standard and metric ruler on the handle of their hand tool. This feature enables an individual to multi-task, thereby increasing productivity. The present invention offers users the ability to use one tool in place of two, freeing up a hand for additional use.

### BRIEF DESCRIPTION OF THE SEVERAL VIEWS OF THE DRAWINGS

FIG. 1 shows one embodiment of a hammer being used to measure the distance between two nails.

FIG. 2 shows measurements on a hammer.

FIG. 3 shows one embodiment of a hammer having measurements in both the standard and metric system.

FIG. 4 shows another embodiment of a hammer.

FIG. 5 shows another embodiment of a hammer.

FIG. 6 shows a perspective view of a cross section of one embodiment of a handle.

FIG. 7 depicts a cross section of one embodiment of a handle having LEDs embedded within the handle.

FIG. 8 shows another embodiment of a hammer having a slideably mounted extendable handle.

FIG. 9 shows another embodiment of a hammer having a pivotably mounted extendable handle.

### DETAILED DESCRIPTION OF THE INVENTION

The present disclosure details a quick and convenient method for taking measurements while working with a hand tool for driving nails, screws, or the like into a surface (e.g., a hammer). While the following description refers to a hammer as the preferred illustrative embodiment, other hand tools with similar shape and purpose may be used to implanted the described embodiments. For example, pneumatic guns, power drills, or similar hand tools may be used.

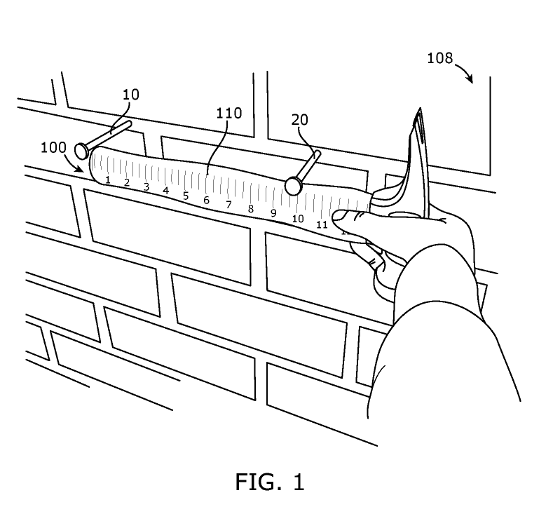

A hammer includes an integrated measuring tool. The unit of measure may vary. FIG. 1 shows a hammer according to the present disclosure being used to measure the distance between two nails. As shown, the hammer 100 functions as normal, but the addition of measurements 110 (e.g., 1″ increments engraved on the handle of the hammer) allows a user to use the hammer 100 to measure distances. The measurements 110 may include regularly spaced markings to represent distance and numeric values to associate particular markings with total distance. By doing so, an individual working with the hammer 100 may hammer in a first nail 10 into working surface 108 and use the hammer to measure the placement of a second nail 20 relative to the first nail 10 with a single hand, thereby leaving the other hand available for holding the second nail at the proper location for hammering. This tool advantageously allows an individual to hammer multiple nails at properly measured intervals without having to put down the hammer to pick up a measuring tape while leaving one hand available for holding nails in place or marking the nailing location.

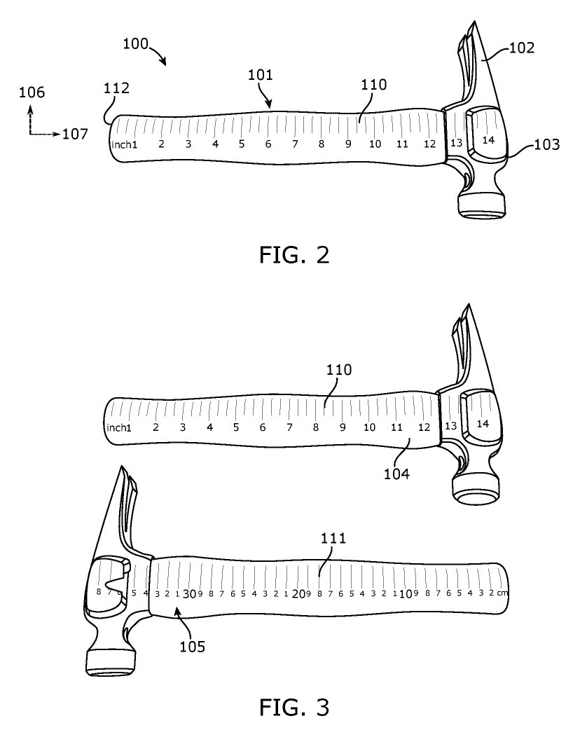

As shown in FIG. 2, the hammer 100 includes a handle 101 and a head 102. The measurements 110 may begin at the handle end 112 of the hammer and extend all the way to the head end 103 along axis 107. The head 102 may include a claw for removing nails and a blunt end for impacting nails. In other embodiments, the measurements may begin at the head end 103 of the hammer depending on the length of the handle and the overall size of the tool. In other words, the measurements 110 may start at “zero” from either end of the hammer. In some embodiments, the “zero” may be at the midpoint of the hammer between the handle end 112 and the head end 103.

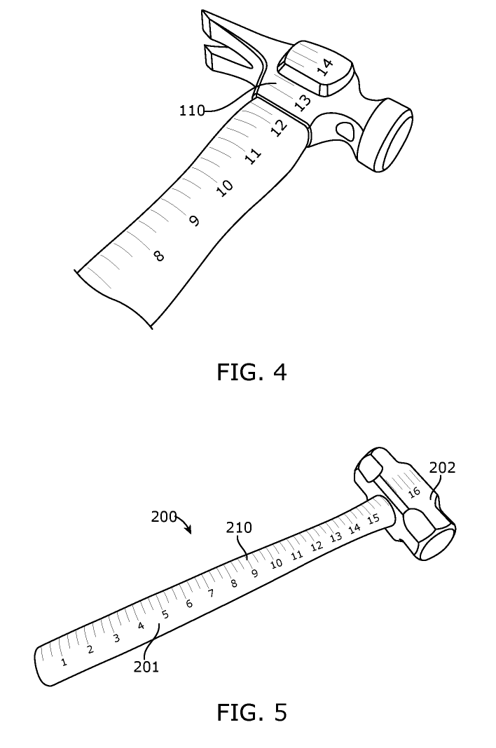

FIG. 3 depicts an embodiment having measurements on both sides of the hammer. As shown in FIG. 3, the increments can be engraved in standard measurement system on one side and then metric system on the other side. A first side 104 of the hammer includes standard measurements 110 having an inch as the base unit. A second side 105 of the hammer includes metric measurements 111 having a centimeter as the base unit. The measurements 110 and 111 may include incremental markings (e.g., quarter-, eighth-, and sixteenth-inch markings for standard measurements 110 and/or millimeter markings for metric measurements 111) and may also include additional markings for commonly used distances, like for example the typical spacing between joists as required by building codes. Other measurement systems and markings may be used in alternative embodiments. As shown in FIG. 4, the measurements 110 may continue from the hammer handle onto the hammer head. While it is preferable to include measurements on a side of the hammer (e.g., side 104 and side 105) so that the hammer may lay flush against a working surface, measurements may be included along other sides of the hammer to provide additional measurement systems. Alternatively or additionally, the hammer head may have a measurements along axis 106 (not shown) so that the user need only rotate the hammer while still gripping to handle to measure shorter distances. Because striking may wear the blunt or striking surface of the head, the “zero” along axis 106 is preferably placed away from the blunt or striking surface.

The measurements may be applied to the hammer via a method other than engraving depending on the material of the hammer and handle. For example, the measurements may be applied to a hammer via laser or acid etching or ink, or they may be pressed or molded into the hammer handle and/or head. This concept may be applied to hammers of various types, sizes, and materials like the hammer 200 shown in FIG. 5. The hammer may be powered by compressed air (e.g., a nail gun). The exact specifications may vary upon manufacturing.

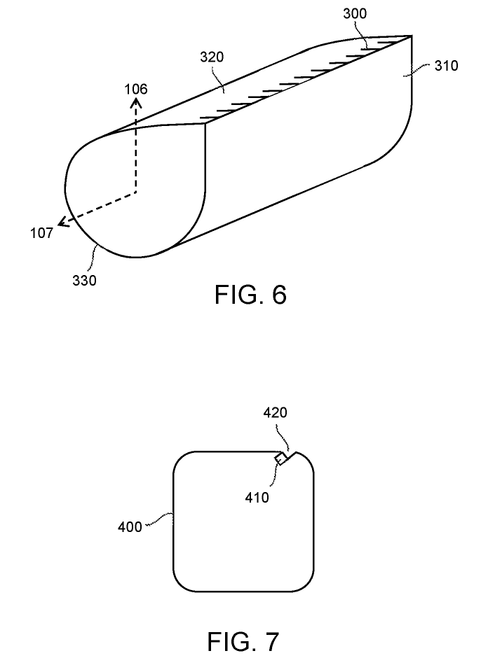

The hammer may include various handle modifications to improve the accuracy of the measurements. For example, in one embodiment, handle may have a cross section as shown in FIG. 6. As shown in FIG. 6, the handle has a first surface 310 which is relatively flat to lay against a working surface, a second surface 320 that meets the first surface 310 at an angle less than 90 degrees to allow the user to better see the measurements 300 when the hammer is against the working surface, and a third surface 330. The joint between first surface 310 and second surface 320 may be slightly rounded to provide a more comfortable grip so long as the measurements 300 remain visible when first surface 310 is placed against a working surface. In such a case, the angle may be measured between the flattest portions of first surface 310 and second surface 320 rather than at the rounded joint. Third surface 330 may be round (as shown) or a plurality of surfaces. Together, the first surface 310, second surface 320, and third surface 330 form a cross section that fits comfortably in a user's hand when holding the hammer.

In one embodiment, a rechargeable and/or replaceable battery is included within the handle for powering a light source, such as light emitting diodes (LED), within the handle. For example, a plurality of LEDs or an LED strip light is enclosed within the handle longitudinally from the head to the handle end. A side of the handle with measurements include openings through which the LED light shines. The openings are provided so as to project light onto a working surface when the edge of the handle is pressed against the working surface. FIG. 7 depicts a cross section of one embodiment of a handle having LEDs embedded within the handle to project light onto the working surface. Handle 400 includes an opening 420 through which light may shine from LED 410. Opening 420 may be covered or filled with a transparent material for durability. A filter may be used to project particular shapes onto the working surface, such as a hash marks and/or numeric values (e.g., the number “5” may be projected at the 5″ mark). Other numbers or shapes may be projected at each LED location (e.g., larger hash marks at integer measurement locations, smaller hash marks at sub-integer locations).

The LEDs may be activated by the user or automatically when the hammer is in a measuring position. For example, a button may be placed on one or both sides of the hammer. The button may be activated, for example, when pressing a side of the handle against a wall or by the user. The button may be a pressure switch. When activated, the button or switch turns on the LEDs and the measuring markings are projected on the wall for easily locating the proper spot for hammering a nail. Other types of switching mechanisms may be employed.

In one alternative embodiment, a slider is provided that is moved longitudinally along the handle. A user slides the slider to the desired measurement location. In use, once the handle is pressed against the wall, light protrudes through the slider projecting against the wall and illuminating the proper spot for hammering. Different sliders may be employed in different embodiments. For example, in one embodiment, a slider that blocks all the light openings except the one for the desired measurement is provided. In an alternative embodiment, a slider that includes a color filter lens to change the color for the LED light projected through the opening corresponding to the desired measurement. For example, white LED light may be used to identify the desired measurement location.

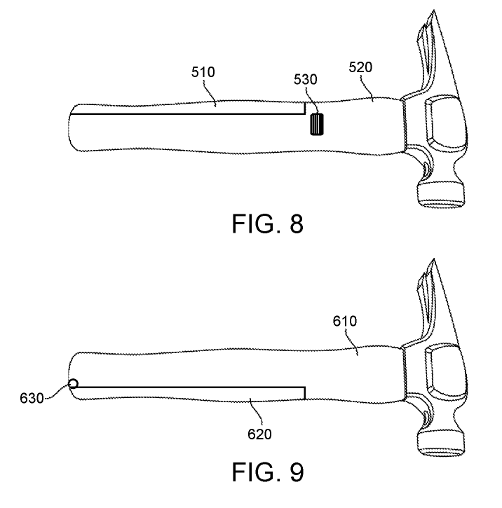

In some embodiments, the handle may be extendable for measuring distances that are larger than the length of the hammer handle. FIGS. 8 and 9 depict embodiments allowing the hammer handle to extend. As shown in FIG. 8, hammer handle is comprised of a first part 510 and a second part 520. Part 510 may be slideably linked to part 520. Part 510 may snap into or be otherwise secured to part 520 to prevent part 510 from moving during hammering. If a securing mechanism is present, a user may disengage it and slide part 510 to extend the range of measurement that may be taken with the hammer (measurements not shown). Alternatively, a thumb wheel 520 may be positioned on part 520 that, through one or more internal gears, may slide part 510 relative to part 520. Measurement markings (not shown) may be included on either side of part 510 and on part 520 underneath part 510 when part 510 is not extended. As shown in FIG. 9, hammer handle is comprised of a first part 610 and a second part 620. Part 620 is mounted relative to part 610 via pivot 630. A securing mechanism may hold part 620 fixed relative to part 610 when extended measurements are not needed. A user may disengage the securing mechanism (if present) and pivot part 620 until it is in line with part 610. The measurements markings (not shown) may be included on either side of part 620 and on part 610 underneath part 620 when part 620 is not extended. The positioning of the movable part of the handle relative to the hammer head may vary, and may be positioned on the back of the unmovable part of the handle (as shown in FIG. 8), on the front of the unmovable part of the handle (as shown in FIG. 9) or on either side of the handle.

The foregoing descriptions of specific embodiments of the present invention have been presented for purposes of illustration and description. They are not intended to be exhaustive or to limit the present invention to the precise forms disclosed, and many modifications and variations are possible in light of the above teaching that are within the scope of the invention. The exemplary embodiments were chosen and described in order to best explain the principles of the present invention and its practical application, to thereby enable others skilled in the art to best utilize the present invention and various embodiments with various modifications as are suited to the particular use contemplated.

1. A hand tool comprising:
a handle having a proximal end, a distal end, a first side, and a second side opposite the first side;
a head secured to the distal end; and
a plurality of measurement markings on the handle.

2. The hand tool of claim 1 wherein the plurality of measurement markings represent a measurement system having a first base unit.

3. The hand tool of claim 2 wherein the plurality of measurement markings are on the first side of the handle and further comprising a second plurality of measurement markings on the second side of the handle.

4. The hand tool of claim 3, wherein the second plurality of measurement markings represent a measurement system having a second base unit that is different from the first base unit.

5. The hand tool of claim 2, wherein the plurality of markings include markings representing increments of the first base unit and markings representing fractions of the first base unit.

6. The hand tool of claim 2, further comprising a plurality of numeric markings that increment, each of the plurality of numeric markings identifying a marking of the plurality of measurement markings associated with an increment of the base unit.

7. The hand tool of claim 1, wherein one or more markings of the plurality of measurement markings are engraved on the first side.

8. The hand tool of claim 1, wherein one or more markings of the plurality of measurement markings are etched on the first side.

9. The hand tool of claim 1, wherein one or more markings of the plurality of measurement markings are printed on the first side.

10. The hand tool of claim 1, wherein one or more markings of the plurality of measurement markings are molded on the first side.

11. The hand tool of claim 1, wherein one or more markings of the plurality of measurement markings extend onto a first side of the head.

12. The hand tool of claim 1, wherein the hand tool is a hammer.

13. The hand tool of claim 12, wherein the head includes a blunt portion and a claw portion.

14. The hand tool of claim 1, further comprising a second plurality of measurement markings on the head, the second plurality of measurement markings being perpendicular to the plurality of measurement markings on the handle.

15. The hand tool of claim 4, wherein the first base unit is inches and the second base unit is centimeters.

16. The hand tool of claim 1, wherein the handle is extendable.

17. The hand tool of claim 1, wherein the handle further comprises an inner cavity enclosing a light.

18. The hand tool of claim 17, wherein one or more markings of the plurality of measurement markings are openings to the inner cavity on the first side through which the light can shine.

19. The hand tool of claim 17, wherein the light comprises one or more light emitting diodes.
